(19) United States
(12) Patent Application Publication
(10) Pub. No.: US 2013/0334329 A1
(43) Pub. Date: Dec. 19, 2013

(54) Method for Heating an Interior of a Motor Vehicle

(71) Applicants: Matthias Lederbogen, Blaubeuren (DE); Gerald Post, Suessen (DE)

(72) Inventors: Matthias Lederbogen, Blaubeuren (DE); Gerald Post, Suessen (DE)

(73) Assignee: Daimler AG, Stuttgart (DE)

(21) Appl. No.: 13/997,009

(22) PCT Filed: Nov. 17, 2011
(86) PCT No.: PCT/EP11/05800

§ 371 Date: Sep. 6, 2013

(30) Foreign Application Priority Data
Dec. 24, 2010 (DE) 10 2010 056 208.4

(51) Int. Cl. B60H 1/02

(52) U.S. Cl. CPC B60H 1/02
USPC 237/81

(57) ABSTRACT

A method for heating an interior of a motor vehicle having a fuel cell, a climate measuring device by which a climate parameter of the interior of the motor vehicle is measured, and a heat transfer device for transferring heat that is generated by the fuel cell to the interior of the motor vehicle. At least one operating parameter of the fuel cell is set also as a function of the climate parameter of the interior of the motor vehicle so that the rate of the heat that is generated by the fuel cell depends on the operating parameter.

### BACKGROUND AND SUMMARY OF THE INVENTION

The invention relates to a method for heating an interior of a motor vehicle, wherein the motor vehicle has a fuel cell.

U.S. patent document US 2004/0195345 A1 describes a device for air conditioning an interior of a motor vehicle, wherein waste heat of a fuel cell of the motor vehicle is used by a heat transfer device for heating air, and the heated air is supplied to the interior. The device has an electrically operated heating unit as an additional heat source for further heating of the air supplied to the interior.

French patent document FR 2819760 A1, related to the same species, describes a method for heating an interior of a motor vehicle, in which an electrical power of a fuel cell is set as a function of a heat demand of the interior, and waste heat of the fuel cell is used for heating the interior. When there is an increased heat demand for the interior, the electrical power of the fuel cell, and thus also the waste heat of the fuel cell, is increased. Excess electrical power of the fuel cell is used for charging a battery.

Exemplary embodiments of the present invention allow an increase in the electrical power of a fuel cell, even when a state of charge of a battery allows no further electrical loading of the battery.

The motor vehicle has a fuel cell, a climate measuring device, and a heat transfer device for transferring heat that is generated by the fuel cell to the interior of the motor vehicle.

The fuel cell may supply electrical energy for an electric travel drive of the motor vehicle, or also for other electrical consumers of the motor vehicle. In addition, the fuel cell may provide electrical energy for charging an electrical energy store.

At least one climate parameter of the interior of the motor vehicle is determined by means of the climate measuring device. The climate parameter is a parameter that reflects a physical climate variable prevailing in the interior, such as an interior temperature or an interior humidity; however, the climate parameter may also be a desired climate variable which a driver or a passenger of the motor vehicle has entered in an air conditioning control unit. Examples of a desired climate variable are a setpoint interior temperature or a setpoint interior humidity.

The heat transfer device is designed in such a way that it establishes a thermal coupling between the interior and the fuel cell. The heat transfer device is composed of one or more heat exchanger systems, wherein heat that is generated by the fuel cell is transported into the interior of the motor vehicle via the heat exchanger(s).

According to exemplary embodiments of the present invention, at least one operating parameter of the fuel cell, in addition to other dependencies, is set as a function of the climate parameter of the interior of the motor vehicle, wherein a rate of the heat that is generated by the fuel cell depends on the operating parameter. In this way, the heat generated by the fuel cell is set as a function of the climate parameter. The rate of the heat is understood to mean a quantity of heat generated per unit time.

The advantage of the present invention over the prior art is that the interior may be efficiently heated due to the regulation of the heat generation of the fuel cell as a function of the climate parameter. In the case of the conventional systems having unregulated heat generation of the fuel cell, additional heat requirements, which are present, in particular for cold outside temperatures, must be met by additional heating units. Such additional heating units are an electric air heater or electric water heater in particular.

The at least one operating parameter of the fuel cell is advantageously an electrical power of the fuel cell or a value that depends on the electrical power. The heat generation of the fuel cell is a function of the set electrical power of the fuel cell. The higher the electrical power, the higher the heat generation. In addition, an electrical efficiency of the fuel cell is a function of the electrical power of the fuel cell. The electrical efficiency is understood to mean a quotient formed by dividing the electrical power of the fuel cell by a total power of the fuel cell, the total power being formed by adding the electrical power and the thermal output. The electrical efficiency of the fuel cell has, under otherwise equivalent conditions, a maximum at a given electrical power. If the electrical power is increased starting from this maximum, the heat generation, i.e., the thermal output, increases, on the one hand due to the increase in the electrical power and on the other hand due to the impairment of the electrical efficiency. The at least one operating parameter may also be a volumetric flow or a partial pressure of a reaction gas of the fuel cell. Reaction gases are usually hydrogen and oxygen, the oxygen typically being supplied to the fuel cell in the form of air. The electrical efficiency of the fuel cell may be decreased, and thus, the heat generation increased, by reducing the volumetric flow or the partial pressure of the reaction gases.

The method may be used in a particularly advantageous manner in a motor vehicle which in addition to the fuel cell has a high-performance electrical energy store. The electrical energy store may supply electrical energy for the electrical travel drive of the motor vehicle, or also for the other electrical consumers of the motor vehicle. In this case, the method is advantageously designed in such a way that the electrical power of the fuel cell and an electrical power output of the electrical energy store are changed in opposite directions as a function of the climate parameter. For example, the electrical power of the fuel cell is increased and the electrical power, i.e., the electrical power output, of the electrical energy store is decreased, as a function of the climate parameter. In this way, the heat generation of the fuel cell may be regulated in the above-mentioned manner, and a total electrical power of a system composed of the fuel cell and the electrical energy store may be held constant or set independently of the heat generation of the fuel cell.

Another advantageous embodiment of the invention provides that the climate parameter is a temperature of the interior, in this case the climate measuring device having a temperature sensor for measuring the temperature of the interior. Alternatively, the climate parameter may be a humidity of the interior, in this case the climate measuring device having a humidity sensor. Alternatively, the climate parameter may be a setpoint temperature of the interior, the setpoint temperature being specified by a driver or passenger of the motor vehicle. The specification by the driver or passenger may be carried out using a control device of an air conditioning unit, for example. Alternatively, the climate parameter may be a difference between the setpoint temperature and the temperature, i.e., an actual temperature, of the interior. Alternatively, the climate parameter may be a volumetric flow of warm air for transferring heat from the heat transfer device to the interior. Alternatively, the climate parameter may be a humidity of the interior. Alternatively, the climate parameter may be a value formed from the above-mentioned variables.

A heat demand for the interior heating may be advantageously derived from the above-mentioned variables. If the heat demand for heating the interior is low, the fuel cell is advantageously operated at a maximum electrical efficiency, and in this case the waste heat of the fuel cell is sufficient for heating the interior according to the method. If the heat demand for heating the interior is large, the fuel cell is operated according to the invention in such a way that its heat generation increases to cover the increased heat demand.

In one advantageous refinement of the method, the heat transfer device has a cooling circuit for cooling the fuel cell, and an interior air heating device, the cooling circuit and the interior air heating device being thermally coupled. In this arrangement, heat losses in the transfer of heat generated by the fuel cell to the interior may be kept low.

Further advantages and features result with reference to the following description of exemplary embodiments and with reference to the drawings, in which equivalent elements are provided with identical reference numerals.

### BRIEF DESCRIPTION OF THE DRAWING FIGURES

The figures show the following:

FIG. 1 shows a schematic illustration of a motor vehicle suited for the use of a method according to the invention; and

FIG. 2 shows a schematic illustration of the method according to the invention, with reference to a function diagram.

### DETAILED DESCRIPTION

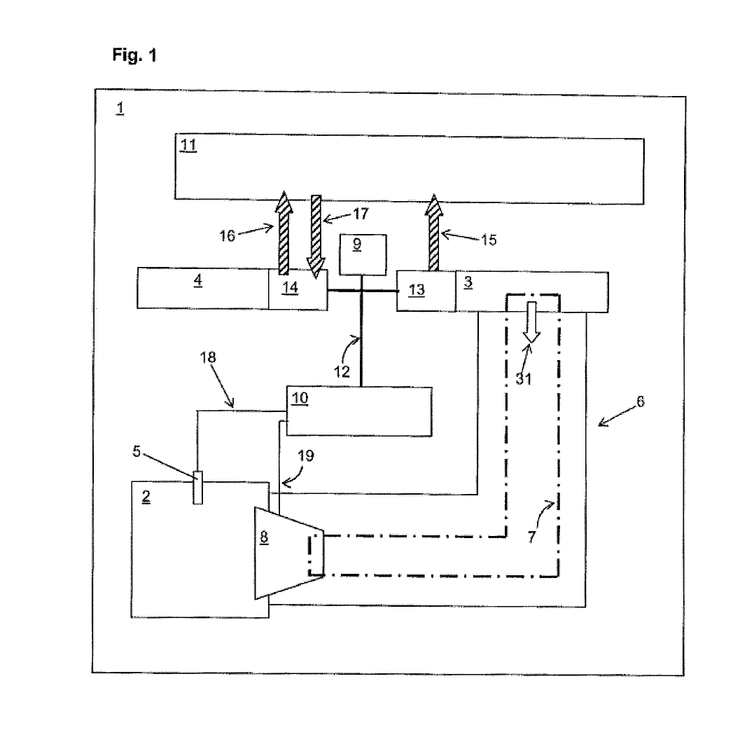

FIG. 1 shows a schematic illustration of a motor vehicle 1 suited for the use of a method according to the invention. The motor vehicle 1 has an interior 2, a fuel cell 3, and an electrical energy store in the form of a traction battery 4. The traction battery 4 is a high-voltage battery. The fuel cell 3 and the traction battery 4 are connected to an electrical system 11 via lines (not illustrated), an electrical drive system (not illustrated in greater detail) is part of the electrical system 11. The fuel cell 3 delivers fuel cell electrical power 15 to the electrical system 11 via a fuel cell power electronics system 13. Likewise, the traction battery 4 delivers traction battery electrical power 16 to the electrical system 11 via a traction battery power electronics system 14. The traction battery 4 also receives generator electrical power 17 which is generated by a generator system (not illustrated) contained in the electrical system 11.

The motor vehicle 1 also has a climate measuring device 5 in the form of a temperature sensor mounted at an appropriate location in the interior 2. During operation of the fuel cell 3, heat 31 is generated, which is initially transferred from the fuel cell 3 to a heat transfer device 6. The heat transfer device 6 has a cooling circuit 7 and an interior air heating device 8. The heat 31 generated by the fuel cell 3 is transferred essentially via the cooling circuit 7 to the interior air heating device 8. An air stream (not illustrated in greater detail) is heated in the interior air heating device 8, and after being heated is supplied to the interior 2. An air heating power P(L) may be set by means of the interior air heating device 8. The motor vehicle 1 has a control unit system for control and regulation of the motor vehicle 1 by the method according to the invention. The control unit system has a climate control unit 10, the fuel cell power electronics system 13, the traction battery power electronics system 14, and a power management control unit 9.

The control unit 10, the fuel cell power electronics system 13, the traction battery power electronics system 14, and the power management control unit 9 are interconnected via a communication network 12 by means of which data may be exchanged. The communication network 12 has a CAN bus system. The climate measuring device 5 is connected to the control unit 10 via a sensor line 18. The control unit 10 is also connected to the air heating device 8 via a control line 19, so that the air heating power may be set by means of the control unit 10.

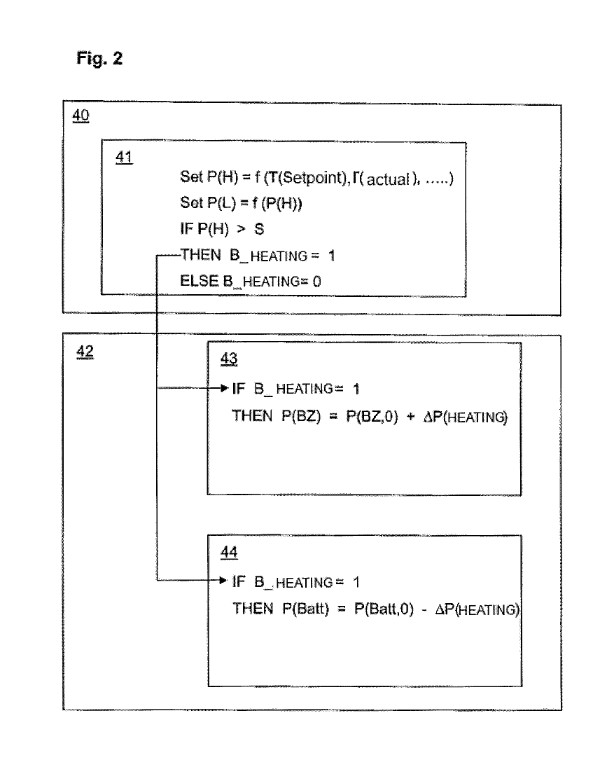

FIG. 2 shows a schematic illustration of the method according to the invention with reference to a function diagram.

The method according to the invention has an interior heating function 41 for controlling and regulating an interior heating system. The interior heating function 41 is part of an air conditioning function 40 for controlling and regulating an interior air conditioning system. The air conditioning function 40 is carried out by the climate control unit 10, using suitable hardware and software means in addition to other functionalities. The interior heating function 41 has means for setting an interior heating power P(H). The interior heating power P(H) is thus set as a function of an interior setpoint temperature T(setpoint), which is specified by a driver or a passenger of the motor vehicle 1, and as a function of an interior actual temperature T(actual) prevailing in the interior 2. In addition, the air heating power P(L) is set as a function of the set interior heating power P(H).

Corresponding to the set air heating power P(L), the air heating device is controlled via the control line 19 for setting the air heating power P(L).

The interior heating function 41 sets a heating status B_HEATING as a function of the set interior heating power P(H). A value of 1 is associated with the heating status B_HEATING when the set interior heating power P(H) is greater than a threshold value S, and a value of 0 is associated with the heating status B_HEATING when the set interior heating power P(H) is less than the threshold value S. The threshold value S depends on, among other things, the heat 31 generated by the fuel cell 3, so that the heating status B_HEATING receives the value 1 when the heat 31 is not sufficient to produce the desired interior heating power P(H) in the air heating device 8.

The method according to the invention also has a power management function 42 for controlling and regulating an electrical power management system of the fuel cell 3 and of the battery 4. The power management function 42 is carried out by the power management control unit 9, using suitable hardware and software means in addition to other functionalities.

By means of the power management function 42 of the power management control unit 9, a required total electrical power is distributed to an electrical power P(BZ) of the fuel cell 3 and an electrical power P(batt) of the battery 4. As long as the heating status B_HEATING has the value 0, the distribution according to the method is such that a maximum electrical efficiency results. In this case, an electrical base power P(BZ,0) of the fuel cell 3 and an electrical base power P(batt,0) of the battery 4 are present. The distribution may vary, depending on various parameters such as a component temperature or the total electrical power, for example.

When the heating status B_HEATING has the value 1, the electrical power P(BZ) of the fuel cell 3 is increased by a heating power AP by means of a fuel cell load management function 43 within the power management function 42. This also necessarily results in an increase in the heat 31 generated by the fuel cell 3, by means of which ultimately the air heating power P(L) may also be increased and is also increased. At the same time, in this case the electrical power P(batt) of the battery 4 is decreased by the magnitude of the heating power AP by means of a battery load management function 44, so that the total electrical power remains constant with other conditions unchanged. Increasing the electrical power P(BZ) of the fuel cell 3 results in a decrease in the electrical efficiency of the overall system. However, the resulting additional waste heat, i.e., the increased heat 31, is used for the efficient heating of the interior 2. The overall energy efficiency would be lower for an alternative additional electrical heating of the interior 2 by means of an electric air heater or an electric water heater.

The electrical power P(BZ) of the fuel cell 3 to be set in each case is communicated via the communication network 12 to the fuel cell power electronics system 13, where it is appropriately set. The electrical power P(batt) of the battery 4 that is to be set in each case is communicated via the communication network 12 to the battery power electronics system 14, where it is appropriately set. After the heat 31 generated by the fuel cell 3 is set, the air heating power P(L) is increased.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### List of Reference Numerals

1 Motor vehicle

2 Interior

3 Fuel cell

4 Traction battery

5 Climate measuring device

6 Heat transfer device

7 Cooling circuit

8 Interior air heating device

9 Power management control unit

10 Climate control unit

11 Electrical system

12 Communication network

13 Fuel cell power electronics system

14 Traction battery power electronics system

15 Fuel cell electrical power

16 Traction battery electrical power

17 Generator electrical power

18 Sensor line

19 Control line

31 Heat generated by the fuel cell

40 Air conditioning function

41 Interior heating function

42 Power management function

43 Fuel cell load management function

44 Battery load management function

P(H) Interior heating power

P(L) Air heating power

T(setpoint) Interior setpoint temperature

T(actual) Interior actual temperature

B_HEATING Heating status

P(BZ) Electrical power of the fuel cell

P(batt) Electrical power of the battery

P(BZ,0) Electrical base power of the fuel cell

P(batt,0) Electrical base power of the battery

AP Heating power

1-7. (canceled)

8. A method for heating an interior of a motor vehicle that includes a fuel cell, an electrical energy store, the method comprising:
measuring, by a climate measuring device of the motor vehicle, a climate parameter of the interior of the motor vehicle; and
transferring, by a heat transfer device, heat generated by the fuel cell to the interior of the motor vehicle,
wherein, to heat the interior of the motor vehicle, a rate of the heat generated by the fuel cell is set as a function of the climate parameter, and an electrical power of the fuel cell is set as a function of the climate parameter,
wherein the electrical power of the fuel cell and an electrical power output of the electrical energy store are changed in opposite directions as a function of the climate parameter.

9. The method according to claim 8, wherein, as a function of the climate parameter, the electrical power of the fuel cell is increased and the electrical power of the electrical energy store is decreased.

10. The method according to claim 8, wherein the electrical power of the fuel cell and the electrical power of the energy store are each used, at least in part, as drive power for a travel drive of the motor vehicle.

11. The method according to claim 8, wherein the climate parameter is at least one of:
an actual temperature of the interior,
a difference between a setpoint temperature and the actual temperature of the interior,
a volumetric flow of warm air for transferring heat from the heat transfer device to the interior,
a humidity of the interior,
an external temperature, or
a value formed from the actual temperature of the interior, the difference between the setpoint temperature and the actual temperature of the interior, the volumetric flow of warm air for transferring heat from the heat transfer device to the interior, the humidity of the interior, and the external temperature.

12. The method according to claim 8, wherein the heat transfer device has a cooling circuit for cooling the fuel cell and an interior air heating device, the cooling circuit and the interior air heating device being thermally coupled.
